(19) United States
(12) Patent Application Publication
(10) Pub. No.: US 2014/0037189 A1
(43) Pub. Date: Feb. 6, 2014

(54) Fast 3-D point cloud generation on mobile devices

(71) Applicant: QUALCOMM INCORPORATED, San Diego, CA (US)

(72) Inventors: Andrew M. ZIEGLER, Atlanta, GA (US); Sundeep VADDADI, San Diego, CA (US); John H. HONG, San Jose, CA (US); Chong U. LEE, San Diego, CA (US)

(73) Assignee: QUALCOMM Incorporated, San Diego, CA (US)

(21) Appl. No.: 13/844,680

(22) Filed: Mar. 15, 2013

Related U.S. Application Data
(60) Provisional application No. 61/679,025, filed on Aug. 2, 2012.

(51) Int. Cl. G06T 17/00

(52) U.S. Cl. CPC G06T 17/00
USPC 382/154

(57) ABSTRACT

A system, apparatus and method for determining a 3-D point cloud is presented. First a processor detects feature points in the first 2-D image and feature points in the second 2-D image and so on. This set of feature points is first matched across images using an efficient transitive matching scheme. These matches are pruned to remove outliers by a first pass of s using projection models, such as a planar homography model computed on a grid placed on the images, and a second pass using an epipolar line constraint to result in a set of matches across the images. These set of matches can be used to triangulate and form a 3-D point cloud of the 3-D object. The processor may recreate the 3-D object as a 3-D model from the 3-D point cloud.

### CROSS-REFERENCE TO RELATED APPLICATIONS

This application claims the benefit of and priority under 35 U.S.C. §119(e) to U.S. Provisional Application No. 61/679,025, filed Aug. 2, 2012, titled “Fast 3-D point cloud generation on mobile devices” and which is incorporated herein by reference.

### BACKGROUND

I. Field of the Invention

This disclosure relates generally to systems, apparatus and methods for generating a three-dimensional (3-D) model on a mobile device, and more particularly to using feature points from more than one 2-D image to generate a 3-D point cloud.

II. Background

Generating depth maps and dense 3-D models require a processor able to perform a computationally intensive task. Having enough processing power on a mobile device becomes problematic. Also traditionally 3-D model generation is done on a personal computer (PC), which limits mobility. What is needed is a way of reducing processing requirements and to lower the computational intensity of generating 3-D models. Furthermore, what is needed is a way to provide this functionality on a mobile device. Also, it is sometimes desirable to be able to generate a 3-D model without cloud connectivity.

### BRIEF SUMMARY

Disclosed are systems, apparatus and methods for determining a 3-D point cloud. According to some aspects, disclosed is a method in a mobile device for determining a three-dimensional (3-D) point cloud from a first image and a second image, the method comprising: correlating, in a first pass, feature points in the first image to feature points in the second image, thereby forming feature points with correspondences; determining, for each grid cell of a first plurality of grid cells, a respective projection model, thereby forming a plurality of projection models; finding, in a second pass and for the plurality of projection models, feature points from the feature points with correspondences that fit the respective projection model, thereby forming feature points fitting a projection for each of the first plurality of grid cells; selecting, from feature points fitting the projection, a feature point from each grid cell of a second plurality of grid cells to form a distributed subset of feature points; and computing a fundamental matrix from the distributed subset of feature points.

According to some aspects, disclosed is a mobile device for determining a three-dimensional (3-D) point cloud from a first image and a second image, the mobile device comprising: a camera; a display, wherein the display displays the 3-D point cloud; a processor coupled to the camera and the display; and wherein the processor comprises instructions configured to: correlate, in a first pass, feature points in the first image to feature points in the second image, thereby forming feature points with correspondences; determine, for each grid cell of a first plurality of grid cells, a respective projection model, thereby forming a plurality of projection models; find, in a second pass and for the plurality of projection models, feature points from the feature points with correspondences that fit the respective projection model, thereby forming feature points fitting a projection for each of the first plurality of grid cells; select, from feature points fitting the projection, a feature point from each grid cell of a second plurality of grid cells to form a distributed subset of feature points; and compute a fundamental matrix from the distributed subset of feature points.

According to some aspects, disclosed is a mobile device for determining a three-dimensional (3-D) point cloud from a first image and a second image, the mobile device comprising: means for correlating, in a first pass, feature points in the first image to feature points in the second image, thereby forming feature points with correspondences; means for determining, for each grid cell of a first plurality of grid cells, a respective projection model, thereby forming a plurality of projection models; means for finding, in a second pass and for the plurality of projection models, feature points from the feature points with correspondences that fit the respective projection model, thereby forming feature points fitting a projection for each of the first plurality of grid cells; means for selecting, from feature points fitting the projection, a feature point from each grid cell of a second plurality of grid cells to form a distributed subset of feature points; and means for computing an fundamental matrix from the distributed subset of feature points.

According to some aspects, disclosed is a non-transient computer-readable storage medium including program code stored thereon for determining a three-dimensional (3-D) point cloud from a first image and a second image, comprising program code to: correlate, in a first pass, feature points in the first image to feature points in the second image, thereby forming feature points with correspondences; determine, for each grid cell of a first plurality of grid cells, a respective projection model, thereby forming a plurality of projection models; find, in a second pass and for the plurality of projection models, feature points from the feature points with correspondences that fit the respective projection model, thereby forming feature points fitting a projection for each of the first plurality of grid cells; select, from feature points fitting the projection, a feature point from each grid cell of a second plurality of grid cells to form a distributed subset of feature points; and compute a fundamental matrix from the distributed subset of feature points.

According to some aspects, disclosed is a method in a mobile device for determining a three-dimensional (3-D) point cloud from a first image and a second image, the method comprising: correlating, in a first pass, feature points in the first image to feature points in the second image, thereby forming feature points with correspondences; determining, for each grid cell of a first plurality of grid cells, a respective projection model, thereby forming a plurality of projection models; and clustering at least two grid cells having a common projection model to model a surface.

According to some aspects, disclosed is a mobile device for determining a three-dimensional (3-D) point cloud from a first image and a second image, the mobile device comprising: a camera; a display, wherein the display displays the 3-D point cloud; a processor coupled to the camera and the display; and wherein the processor comprises instructions configured to: correlate, in a first pass, feature points in the first image to feature points in the second image, thereby forming feature points with correspondences; determine, for each grid cell of a first plurality of grid cells, a respective projection model, thereby forming a plurality of projection models; and cluster at least two grid cells having a common projection model to model a surface.

According to some aspects, disclosed is a mobile device for determining a three-dimensional (3-D) point cloud from a first image and a second image, the mobile device comprising: means for correlating, in a first pass, feature points in the first image to feature points in the second image, thereby forming feature points with correspondences; means for determining, for each grid cell of a first plurality of grid cells, a respective projection model, thereby forming a plurality of projection models; and means for clustering at least two grid cells having a common projection model to model a surface.

According to some aspects, disclosed is a non-transient computer-readable storage medium including program code stored thereon for determining a three-dimensional (3-D) point cloud from a first image and a second image, comprising program code to: correlate, in a first pass, feature points in the first image to feature points in the second image, thereby forming feature points with correspondences; determine, for each grid cell of a first plurality of grid cells, a respective projection model, thereby forming a plurality of projection models; and cluster at least two grid cells having a common projection model to model a surface.

It is understood that other aspects will become readily apparent to those skilled in the art from the following detailed description, wherein it is shown and described by various aspects by way of illustration. The drawings and detailed description are to be regarded as illustrative in nature and not as restrictive.

### BRIEF DESCRIPTION OF THE DRAWING

Embodiments of the invention will be described, by way of example only, with reference to the drawings.

FIG. 1 shows selection of a sequence of images and selected frames.

FIG. 2 illustrates a first image with a plurality of feature points.

FIG. 3 shows a feature point 114 from a first image 110 corresponding to a feature point 124 in a second image 120, in accordance with some embodiments of the present invention.

FIG. 4 shows a first plurality of grid cells, in accordance with some embodiments of the present invention.

FIGS. 5, 6 and 7 illustrate correspondences of a homography model, in accordance with some embodiments of the present invention.

FIG. 8 shows a second plurality of grid cells and a distributed subset of feature points that fit the homography model, in accordance with some embodiments of the present invention.

FIGS. 9 and 10 illustrate a relationship between selected frames, in accordance with some embodiments of the present invention.

FIGS. 11, 12 and 13 show flowcharts, in accordance with some embodiments of the present invention.

FIG. 14 shows blocks of a mobile device, in accordance with some embodiments of the present invention.

FIG. 15 illustrates a relationship among selected images, in accordance with some embodiments of the present invention.

FIGS. 16 and 17 show methods, in accordance with some embodiments of the present invention.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

As used herein, a mobile device, sometimes referred to as a mobile station (MS) or user equipment (UE), such as a cellular phone, mobile phone or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs in the device or in the PND. Also, “mobile station” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs in the device, in a server, or in another device associated with the network. Any operable combination of the above are also considered a “mobile device.”

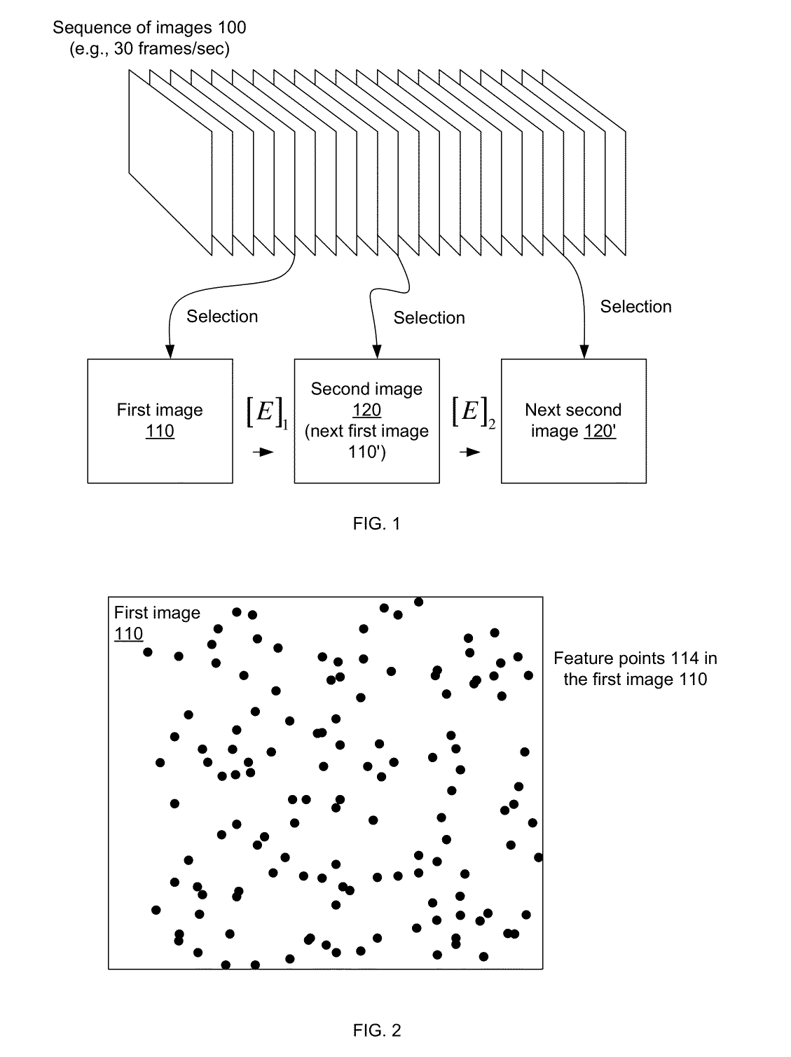

FIG. 1 shows selection of a sequence of images 100 and selected frames. A video stream from a mobile device is received. A frame might be automatically selected from the video stream based on an underlying criterion, alternatively, a user may manually select a frame. A system provides a first image 110 and a second image 120. Periodically, a frame may be sought that meets focus and timing requirements. For example, a frame must be at least partially in focus to allow feature point detection. Furthermore, a frame should not be too close (e.g., separated by less than 10 frames, less than 1 inch of translation) or too far (e.g., separated by greater than 240 frames or four seconds later) from a previous frame. Methods described below explain how a fundamental matrix [F] and an essential matrix [E] are computed from a sequential pair of selected images. Camera projection matrices which result from the decomposition of essential matrix [E] relates corresponding feature points of the sequential pair of selected images such that triangulation may be performed to generate a 3-D point cloud. In turn, a processor uses this 3-D point cloud to create a surface of a 3-D model.

The first image 110 and the second image 120 are selected from sequence of images or frames from a video stream. Alternatively, a user selects the first image 110 and the second image 120. Images are taken from a camera of the mobile device. The process of selecting a first image 110 and a second image 120 may be automatic in real-time or may occur offline by a user.

Translation and rotation of the camera are embodied in the essential matrix [E] or an equivalent fundamental matrix [F], which is an un-calibrated version of the essential matrix [E]. The fundamental matrix [F] is equivalent to and used interchangeably with the essential matrix [E]. The fundamental matrix [F] is un-scaled and the essential matrix [E] is calibrated by an intrinsic matrix [I]. Mathematically, the essential matrix [E] equals the fundamental matrix [F] multiplied by the intrinsic matrix

Let the first camera position be canonical (i.e., defining the origin [0,0,0]). All other camera positions are related to the first camera position. For example, a processor computes the essential matrix [E₁₋₂] between the first position of the camera and a second position of the camera. The essential matrix [E] may be decomposed to a rotation matrix [R] and a translation vector M. For example, the essential matrix [E₁₋₂] from a first position to a second position decomposes into a first rotation matrix [R₁₋₂] and a first translation vector [T₁₋₂]. Similarly, the essential matrix [E₂₋₃] from a second position to a third position decomposes into a second rotation matrix [R₂₋₃] and a second translation vector [T₂₋₃]. Here, the second camera position acts as an intermediate canonical position to a third camera position.

An essential matrix [E] from a last camera position may be mapped back the the first camera position. For example, the essential matrix [E₂₋₃] may be mapped back to the first camera position as essential matrix [E₁₋₃]. The essential matrix [E₁₋₃] from a first position to a third position may be computed from a product of: (1) the essential matrix [E₂₋₃] from the first position to the second position; and (2) the essential matrix [E₂₋₃] from the second position to the third position. This process may be repeated to compute for each new image. Sequential bundle adjustment may be used to refine the estimates of [R₁₋₃], [T₁₋₃] and so on.

FIG. 2 illustrates a first image 110 with a plurality of feature points 114. Each selected image should include an image of a 3-D object having approximately planar sides. This 3-D object includes a number of feature points at corners, edges and surfaces. Perhaps an image includes 1000 to 10,000 feature points belonging to both the 3-D object as well as spurious points not belonging to the 3-D object. The goal is to represent the 3-D object found in the images as a 3-D point cloud.

First, a camera in the mobile device captures a first image 110 at a first location and a second image 120 at a second location having different perspectives on a 3-D object. Next, a processor in the mobile device detects feature points 114 in the first image 110 and feature points 124 in the second image 120. Methods described below reduce this set of feature points by performing a first pass using correlation between images, a second pass using a projection model, and a third pass using a fundamental matrix to result in a dwindling set of feature points most likely to properly represent a 3-D point cloud of the 3-D object. Thus, a processor may recreate the 3-D object as a 3-D model from the 3-D point cloud.

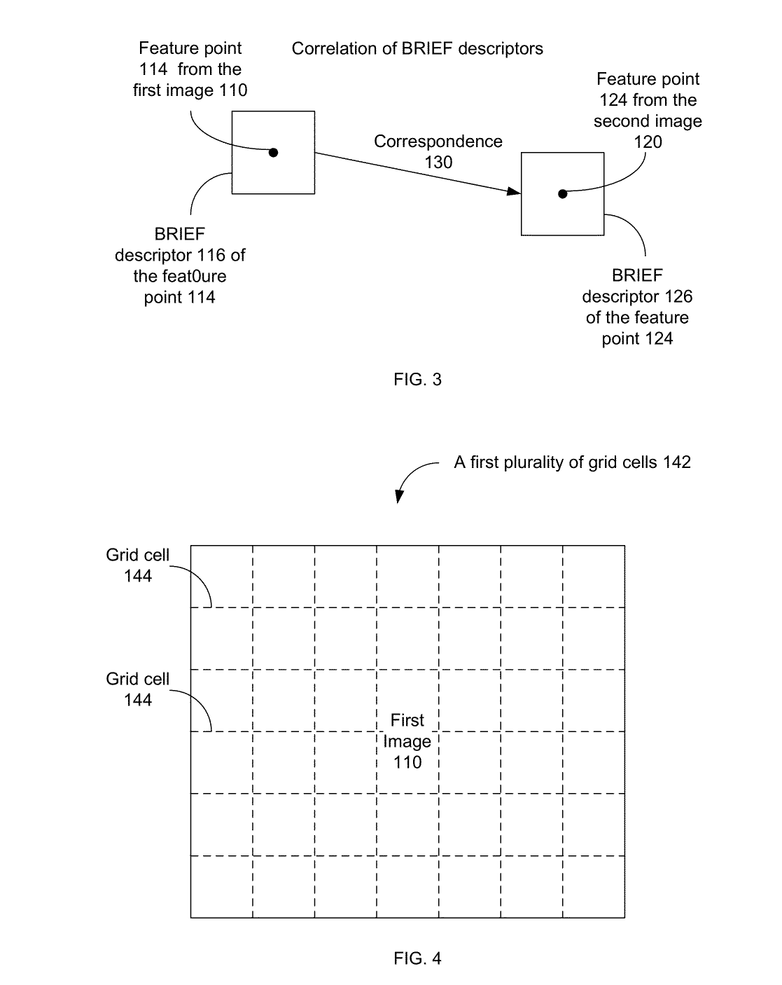

FIG. 3 shows a feature point 114 from a first image 110 corresponding to a feature point 124 in a second image 120, in accordance with some embodiments of the present invention. The feature point 114 and feature point 124 are each described by a local-feature based descriptor, such as a BRIEF descriptor 116 and a BRIEF descriptor 126, respectively. A BRIEF descriptor is a binary robust independent elementary feature descriptor. A BRIEF descriptor quickly and accurately defines a feature point for real-time applications. The BRIEF descriptor 116 from the first image 110 corresponds to the BRIEF descriptor 126 from the second image 120. A different kind of local-feature based descriptor such as SIFT might also be used, with varying efficiency and precision.

First, several feature points are selected and BRIEF descriptors defined in both the first image 110 and the second image 120. For each individual feature point 114 detected in the first image 110, a correlator attempts to correlate a feature point 114 in the first image 110 to a corresponding feature point 124 in the second image 120 by correlating the BRIEF descriptors 116, 126. The correlator may find a correspondence 130, thereby forming feature points with correspondences. The correlator for matching BRIEF descriptors may be based on a Hamming distance.

The first image 110 and the second image 120 represent the sequential pair of selected images. The BRIEF descriptor 116 and BRIEF descriptor 126 surround and represent the feature points 114 and 112 respectively. A correspondence 130 is found by correlating the BRIEF descriptors 116 in the first image 110 with the BRIEF descriptors 127 in the first image 110. The feature points may be divided into a first portion of feature points having a tolerable correlation and a second portion of feature points without a correlation. That is, a correlation with a predetermined tolerance results in the first portion of the feature points 114 in the first image 110 finding a closest match to a particular feature point 124 in the second image 120. The second portion of feature points 114 in the first image 110 may fail to correlate to any feature point 124 of the second image 120. This first pass reduces the candidate feature points from all of the feature points 114 in the first image 110 to just those feature points having a corresponding feature point 124 in the second image 120.

FIG. 4 shows a first plurality of grid cells 142, in accordance with some embodiments of the present invention. The method divides up the first image 110 into a first plurality of grid cells 142 comprising several individual grid cells 144. A grid cell 144 will approximate an area in an image containing a flat surface. The size of each grid cell 144 of the first plurality of grid cells 142 is constrained by processing power of the mobile device and is a balance between a smaller number of grid cells 144 allowing quick processing but coarsely approximating non-planar scenes with planar surface and a larger number of grid cells 144 (or equivalently, a smaller grid cell 144) better defining a non-planar scene.

A processor finds feature points, from the pared down list of feature points having correspondences 130 that fit a projection model, such as a homography model 140, thereby forming feature points fitting a projection. A projection model estimates the grid cell 144 as being a flat plane. A projection model, such as a separate planar homography model 140 (used as an example below), is determined for each grid cell 144.

For example, a processor executes, for each grid cell 144 of the first plurality of grid cells 142, a randomly sampling consensus (RANSAC) algorithm to separate the feature points with correspondences 130 for the grid cell 144 into outlier correspondences and inlier correspondences. Inliers have correspondences that match the homography model 140 for the grid cell 144. Outliers do not match the homography model 140.

The RANSAC algorithm samples points from the grid cell 144 until a consensus exists that shows a current set of samples (e.g., 4 feature points) create an average correspondence that a threshold number of correspondences from that grid cell 144 agree. That is, an appropriate homography model 140 is defined using a trial-and-error RANSAC algorithm. Next, selected homography model 140 is compared to each correspondence. The inliers form the feature points fitting the homography model 140.

The outliers form the feature points not fitting the homography model 140.

Grid cells 144 with a similar or same homography model may be considered a common planar surface across the grid cells 144. As such, these grid cells 144 may be cluster together to define a plane. As a result, a processor may determine where one planar object is located. Instead of a planar homography model, other homography models may be used (e.g., a spherical homography model).

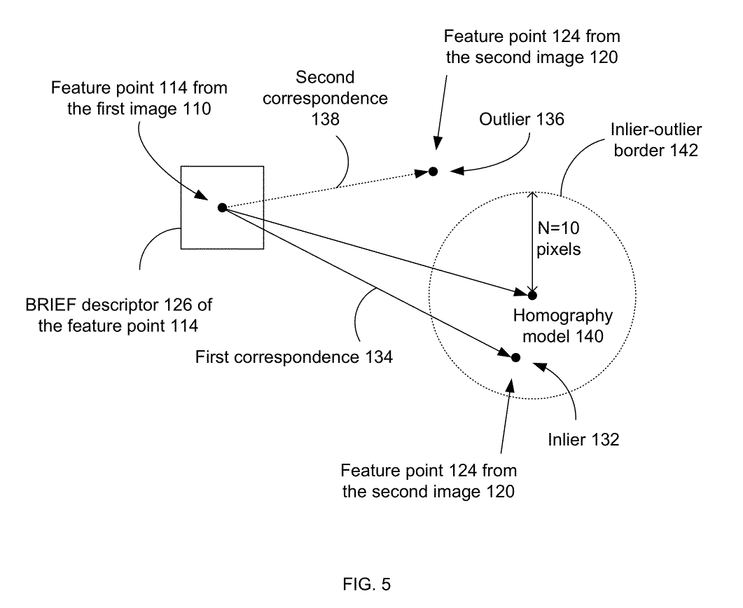

FIGS. 5, 6 and 7 illustrate correspondences of a homography model 140, in accordance with some embodiments of the present invention. In FIG. 5, an adequate or good homography model 140 is selected, for example, using a RANSAC algorithm. Each grid cell 144 has its own homography model 140. Correspondences 130 for feature points 114 and 124 are tested against the homography model 140.

For example, correspondences 134 that fall within a predetermined pixel distance N of the homography model 140 are considered inliers 132 while correspondences 138 that fall outside of the predetermined pixel distance N of the homography model 140 are considered outliers 136. The predetermined pixel distance N may be set loosely to allow more matches or tightly to inhibit correspondences 130 and corresponding feature points 114. The inliers proceed to the next test. The pixel distance N may be set (e.g., to 8, 10 or 12) to allow fewer or more feature points 114 to pass while excluding wild correspondences 138 and other outliers.

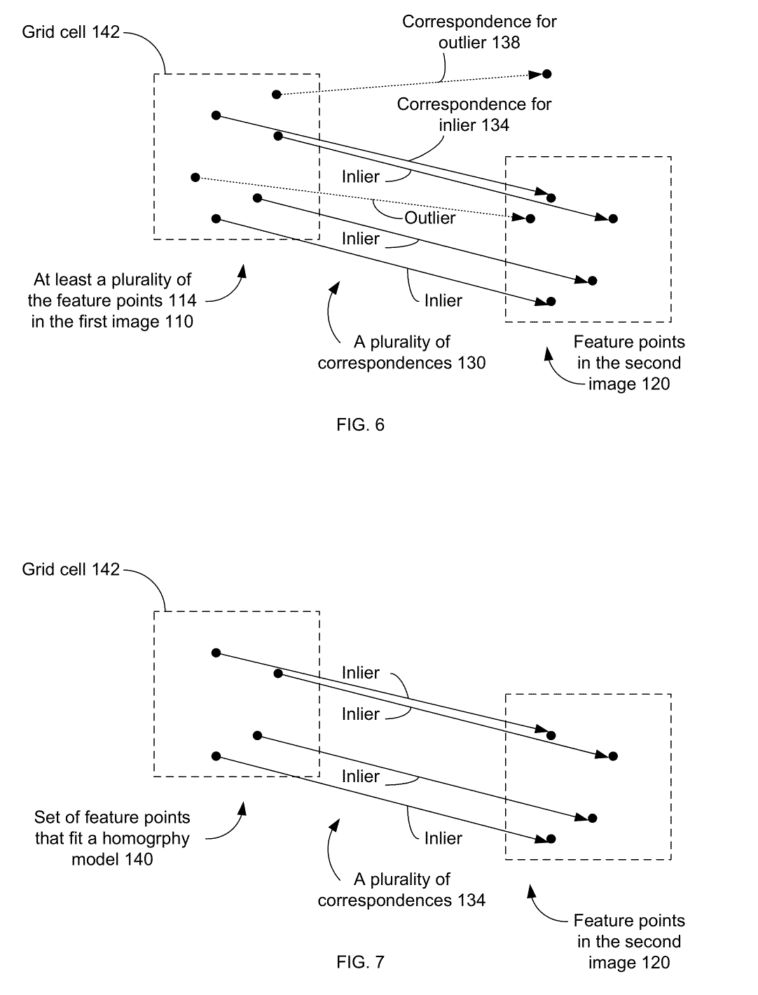

In FIG. 6, a test is performed for all correspondences 130 within a grid cell 144. Once the homography model 140 is determined, inliers 132 may be distinguished from outlines 136. A plurality of feature points 114 from the first image will result in correspondences 134 that are inliers 132, while other feature points and correspondences 138 will be discarded as outliers.

In FIG. 7, only the inliers 132 are saved as having a correspondence 134 that fits the homography model 140. This second pass reduces the candidate feature points still further from feature points 114 having correspondences 130 to only those feature points having a correspondence and meeting the homography model 140 for a particular grid cell 144.

That is, the first pass reduced the candidate feature points by filtering out feature points without correspondences. The second pass further reduced the candidate feature points by filtering out feature points not meeting a homography model for their grid cell 144. A third pass, discussed below, prunes the remaining features using a fundamental matrix based RANSAC across an image. Note in the previous pass we used a planar homography based RANSAC on each individual grid. To create the fundamental matrix, the process uses a second plurality of grid cells 150 comprising a number of individual grid cells 152. The size of a grid cell 152 may be smaller, larger or the same as a grid cell 144.

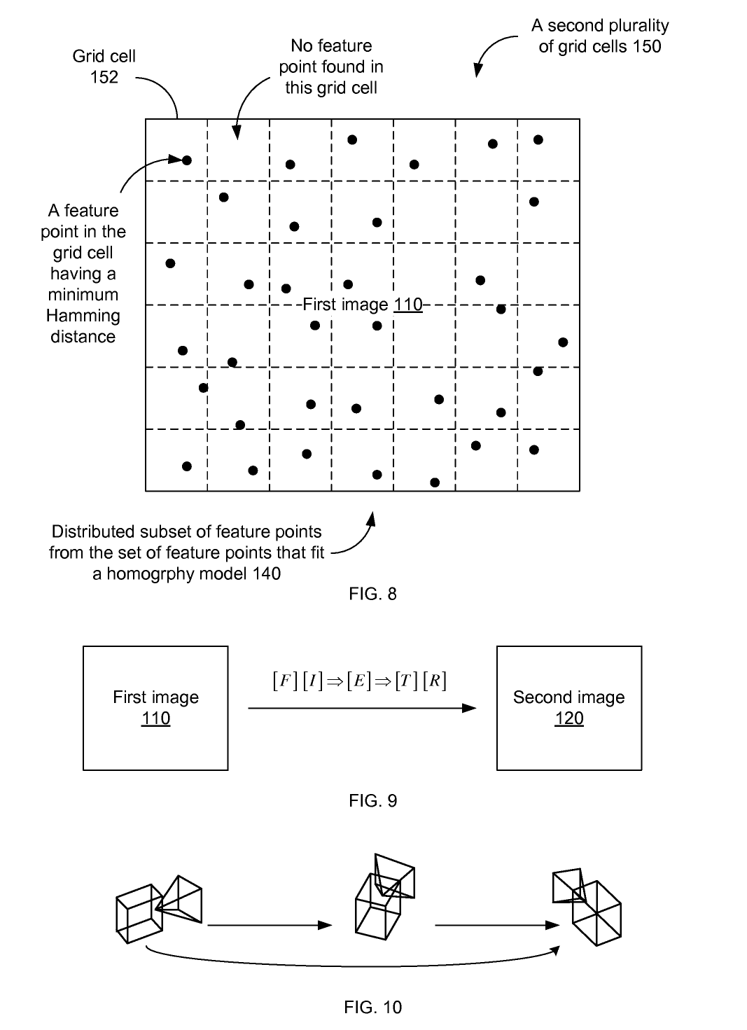

FIG. 8 shows a second plurality of grid cells 150 and a distributed subset of feature points that fit the homography model 140, in accordance with some embodiments of the present invention. For each grid cell 152, a best representative feature point is selected.

FIGS. 9 and 10 illustrate a relationship between selected frames, in accordance with some embodiments of the present invention. In FIG. 9, a relationship between the first and second selected frames is shown. A fundamental matrix is first determined from the first image 110 and the second image 120. The fundamental matrix is calibrated by an intrinsic matrix to form an essential matrix. The essential matrix is decomposed to a translation vector and a rotation matrix.

In FIG. 10, a first image, intermediary image(s) and a last image are captured at respective locations. The mobile device computes a fundamental matrix for the intermediary movement. Fortunately, the overall fundamental matrix or essential matrix may be formed with the product of matrices formed from the incremental movement. As such, otherwise difficult to track translations and rotations from a first image and a last image may be formed as a matrix product of incremental translations and rotations.

The feature points from the second pass (feature points having a correspondence and meeting the homography model 140 for a particular grid cell 144) are whittled down using a third pass. The third pass finds correspondences from the second pass that are consistent with the fundamental matrix. Each correspondences from the second pass is compared to a point to line (epipolar line) correspondence formed by the fundamental matrix to determine whether the correspondence is an inlier or an outlier. A fundamental matrix gives you match between a point and a epipolar line (rather than a point given by the homog model gives you a match b/t points)

For example, correspondences 164 that fall within a predetermined pixel distance M of the model from the essential matrix 170 are considered inliers 162 while correspondences 168 that fall outside of the predetermined pixel distance M of the model are considered outliers 166. The predetermined pixel distance M may be set loosely allow or tightly inhibit correspondences and feature points 114. The pixel distance M may be set (e.g., to 8, 10 or 12) to allow fewer or more feature points 114 to pass while excluding wild correspondences and other outliers 166. This third pass reduces the candidate feature points yet further from feature points 114 passing the test using the homography model 140 to only those feature points also meeting the model from the fundamental matrix 170. Using matches, then compute a fundamental matrix. Fundamental matrix multiplied by intrinsic matrix (where the intrinsic matrix is formed from a function of focal length of the camera) to form an essential matrix. The fundamental matrix is un-calibrated and the essential matrix is calibrated. The essential matrix in turn may be decomposed into camera projection matrixes (i.e., a translation vector and a rotation matrix).

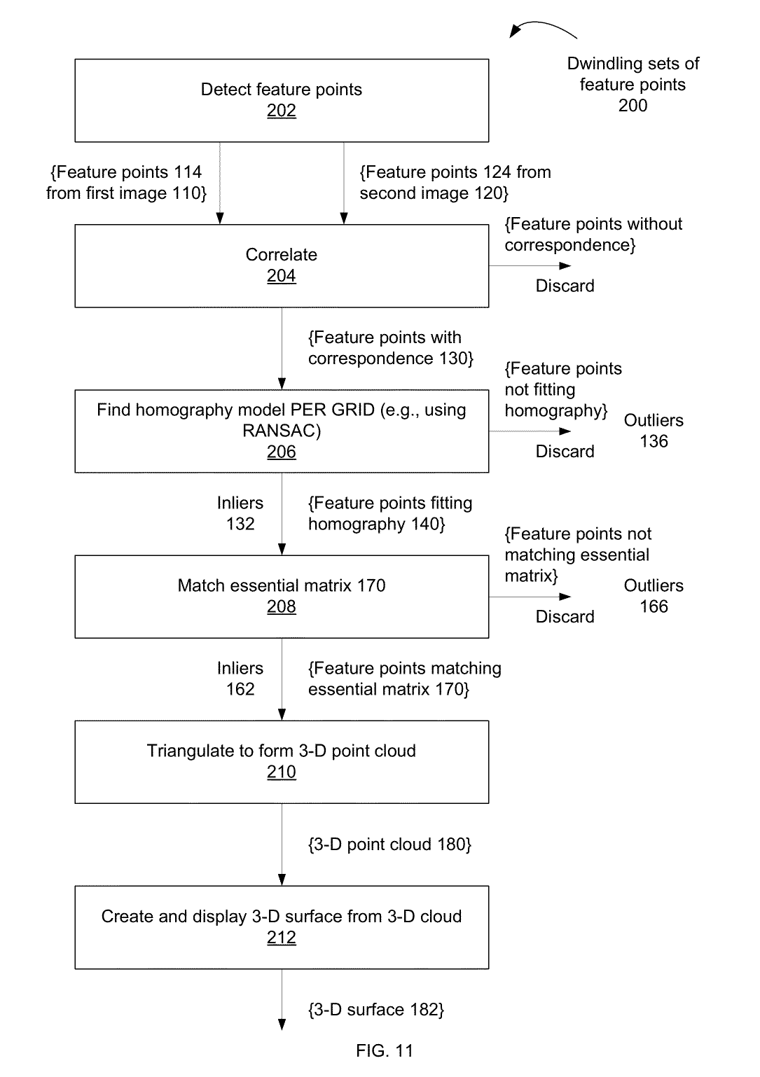

FIGS. 11, 12 and 13 show flowcharts, in accordance with some embodiments of the present invention. In FIG. 11, a method 200 shows how a dwindling set of feature points are determined to a 3-D point cloud for a 3-D surface 182. At 202, feature points are detected in the first and second images. Rather that tracking the feature points, a processor may re-detect the feature points with third, fourth, fifth (each new image). To save processing power, the detected feature points of a second image may be later used and function as the feature points in a next first image. The processor results in a set of feature points 114 from the first image 110 and a set of feature points 124 from the second image 120. The processor determines a descriptor or each feature point in the first and second images 110, 120. For example, a BRIEF descriptor may be created for each feature point.

Traditionally, a system computes matches between frames by searching from every feature in every frame to every other feature in every other frame. This is computationally very expensive with a computation order of approximately N² assuming the number of frames is equal to the number of feature points. As an example, if there are M frames with N features in each, we need to search N*(M−1) features for every N features found in the first frame. This process is repeated for every feature in additional pairs of frames as well. This results in a complexity of N*(M−1) just to match a particular feature in the first frame to all other frames.

According to embodiments described herein, methods simplify this N² complexity to a complexity of order N. First, search for and find features in a frame. Second, place each feature in a disjoint set data structure for the frame. The data structure enables a transitive property across frames (from data structure to data structure) and also enables a determination of matches across non-successive frames by just matching successive frames.

For example, if feature A from frame 1 matched to feature B in frame 2 and feature B from frame 2 matched to feature C in frame 3, transitivity allows an immediately inference that feature A from frame 1 matched to feature C in frame 3 (via feature B from frame 2). This match is inferred without any explicit matching or computation between frame 1 and frame 3.

Complexity of matching one feature in frame 1 to all other frames now reduces to ‘N’ instead of ‘N*(M−1)’. Apart from reducing the matching complexity, this transitive matching scheme also allows use of binary descriptors (e.g., a BRIEF descriptor). Binary descriptors are inexpensive to compute but may not be very robust for large view point changes. Floating point descriptors (e.g., a SIFT descriptor) are naturally more robust across non-successive frames than binary descriptors but are more computationally expensive to compute and process.

Binary descriptors are useful in matching successive frames and using transitive matching allows an inference of matches across non-successive frames. Therefore, binary descriptors give an implicit robustness. Optimally, the mobile device computes a translation and rotation from the first image (i.e., defining [0,0,0]) to a last image. A standard method uses N² complexity by tracking feature points and computing a corresponding match in each image.

According to embodiments described herein, methods may simplify complexity (e.g., to N) by computing feature points with matched descriptors in successive images. Feature points from an image are stored a data structure as a disjointed set of feature points. Feature points that have an explicit match or correspondence remain in the data structure. Feature points without correspondences are not needed. By keeping feature points with correspondences (between successive images), a more robust system may be formed than directly jumping from a first image to a last image. That is, fewer feature points are found matching between the first image and the last image. Those feature points in the first image and last image may be generally more retable found by going through one or more intermediary images.

As such, a feature point to form the 3-D point cloud is found in at least two successive images. Feature points without such a correspondence between successive images are discarded.

At 204, a correlator compares the set of feature points 114 from the first image 110 with the set of feature points 124 from the second image 120. For example, a the correlator correlates the BRIEF descriptors to find a best match between a BRIEF descriptor from the first image 110 with a corresponding a BRIEF descriptor from the second image 120. The correlator results in a set of feature points with a correspondence 130, while discarding the remaining feature points where no correspondence was found. The correlator acts as a first filtering pass.

At 206, a processor finds a homography model 140 (e.g., using a RANSAC algorithm) for each grid cell 144. For example, a homography model 140 is determined for each grid cell 144 from a first plurality of grid cells 142. As a result, some correspondences fit the homography model 140 for that grid cell 144 while other correspondences do not fit the homography model 140. Feature points corresponding to the correspondences fit the homography model 140 are forwarded to the next step as inliers 132 and feature points having correspondences not fitting the homography model 140 for that grid cell 144 are discard as outliers 136. The processor running the homography model 140 acts as a second filtering pass.

At 208, the processor computes a fundamental matrix by combining the feature points fitting the homography model 140. For example, the homography model 140 is sorted in descending with respect to their match strength and the top matches are used to create the fundamental matrix. The processor then matches and compares the feature points fitting the homography model 140 to a features fitting to the fundamental matrix based RANSAC. That is, points matching a model created from the fundamental matrix are forward to a triangulating step (step 210 below) while feature points failing to match the fundamental matrix are discarded as outliers 166. The processor matching feature points to the fundamental matrix acts as a third filtering pass. At 210, the processor triangulates the feature points to form a 3-D point cloud 180. At 212, the 3-D point cloud 180 is used to create and display a 3-D surface. In the above-example, a 3-D point cloud 180 was created with two images. For more accuracy and confidence, a 3-D point cloud 180 may be formed with three to dozens of images or more.

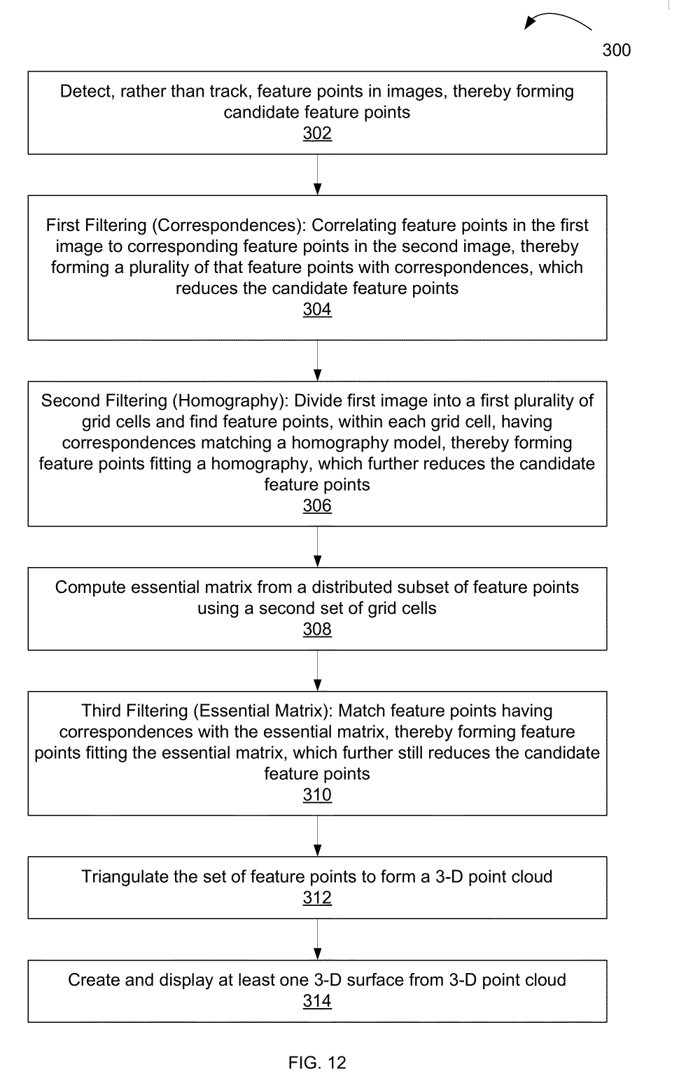

In FIG. 12, a method 300 is shown to create a 3-D projection model. At 302, a processor detects feature points in images. Detection is used rather than tracking of feature points. Rather than tracking feature points, the method described here detects feature points with each new image then whittles down the feature points using various passes until a point cloud of the 3-D object remains. Detection of feature points forms candidate feature points before a first pass.

At 304, a first pass is performed by first filtering the limiting candidate feature points in a first image 110 with a corresponding feature point in a second image 120. The processor correlates a descriptor for each feature point in the first image 110 to a corresponding descriptor of a feature point in the second image 120, thereby forming a plurality of feature points having respective correspondences, which reduces the candidate feature points.

At 306, a second pass is performed by filtering the candidate feature points having correspondences with a homography model 140. The processor divides a first image 110 into a first plurality of grid cells 142 and selects feature points within each grid cell 144 meeting the homography model 140. The homography model 140 may be formed from a RANSAC algorithm to separate the feature points with correspondences 130 in the grid cell 144 into outlier correspondences and inlier correspondences as described above. Candidate feature points having correspondences and matching the homography model 140 for that grid cell 144 form feature points fitting the homography. This second pass further reduces the candidate feature points.

At 308, the processor divides a first image into a second plurality of grid cells 150 with each grid cell identified as grid cell 152. A best feature point from the candidate feature points from each grid cell 152 is selected. The best feature point may be the feature point for that grid cell 152 with the minimum Hamming distance to a homography model 140 for that feature point. The best feature point may be from an average correspondence. The best feature points form a distributed subset of feature points using a second set of grid cells 150. For example, one, two or three feature points may be used from each grid cell 152. A larger number of feature points may be set as an upper limit (e.g., Nₘₐₓ=8 or 50). Feature points may be sorted by matching strength and only the strongest N. may be considered. The processor then computes a fundamental matrix and then an essential matrix for the image pair (i.e., the first image 110 and the second image 120) from the distributed subset of feature points.

At 310, a third pass is performed by filtering the candidate feature points using points defined by the fundamental matrix. The processor matches feature points having correspondences to points computed by the fundamental matrix, thereby forming feature points fitting the fundamental matrix. For example, a processor uses the fundamental matrix on a feature point 114 in the first image 110 to result in a point computed from the fundamental matrix. If the corresponding feature point on the second image is with M pixels from the point predicted by the fundamental matrix, the feature point is considered an inlier. If the feature point is more than M pixels away from the point predicted by the essential matrix, the feature point is considered an outlier. As such, this third pass still further reduces the candidate feature points. The inlier feature points progress to step 312 and the outliers are discarded.

At 312, the processor triangulates the set of feature points after the third pass to form a 3-D point cloud. At 314, the processor creates and displays at least one 3-D surface defined by the 3-D point cloud.

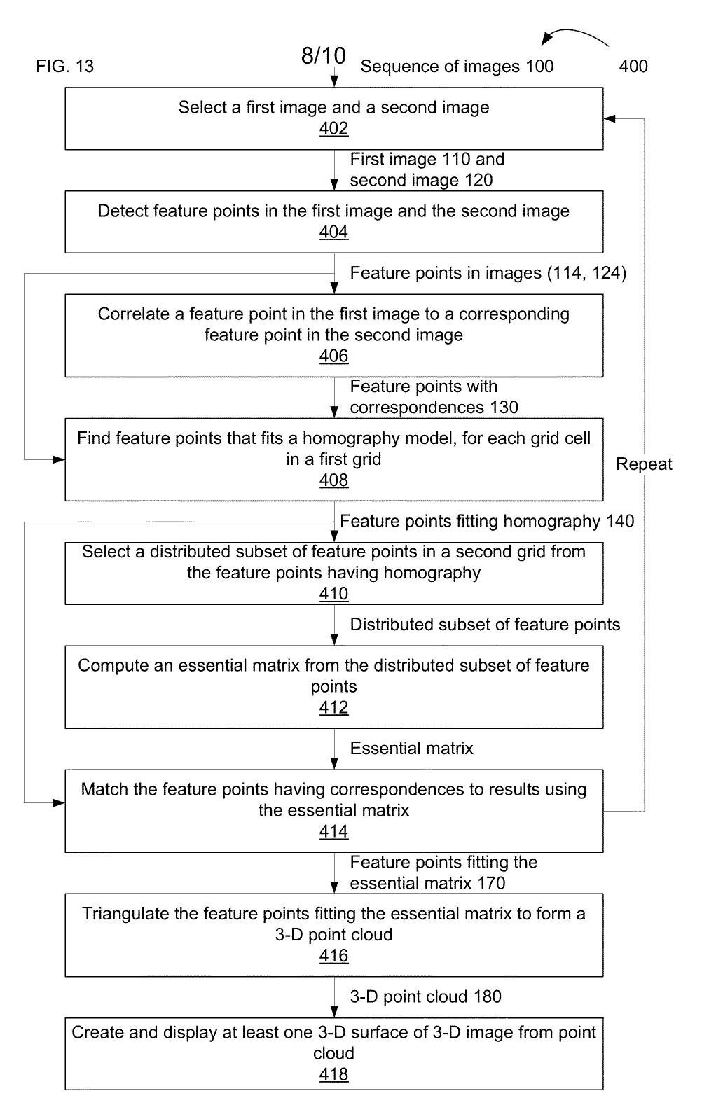

In FIG. 13, a similar method 400 is shown to create a 3-D model. At 402, a processor selects a first image 110 and a second image 120. At 404, the processor detects feature points 114 in the first image 110 and feature points 124 in the second image 120. At 406, the processor correlates feature points 124 in the first image 110 to a corresponding feature point 124 in the second image 120. For example, a correlator can correlate BRIEF descriptors 116 in the first image 110 with BRIEF descriptors 126 in the second image 120. At 408, the processor finds feature points that fit a homography model 140, for each grid cell 144 in a first grid 142. At 410, the processor selects a distributed subset of feature points in a second grid 150 from the feature points fitting the homography model 140. At 412, the processor computes an fundamental matrix from the distributed subset of feature points. At 414, the processor matches the feature points having correspondences to points found using the fundamental matrix. At 416, the processor triangulates the feature points fitting the fundamental matrix to form a 3-D point cloud. At 418, the processor creates and displays at least one 3-D surface of 3-D model from point cloud.

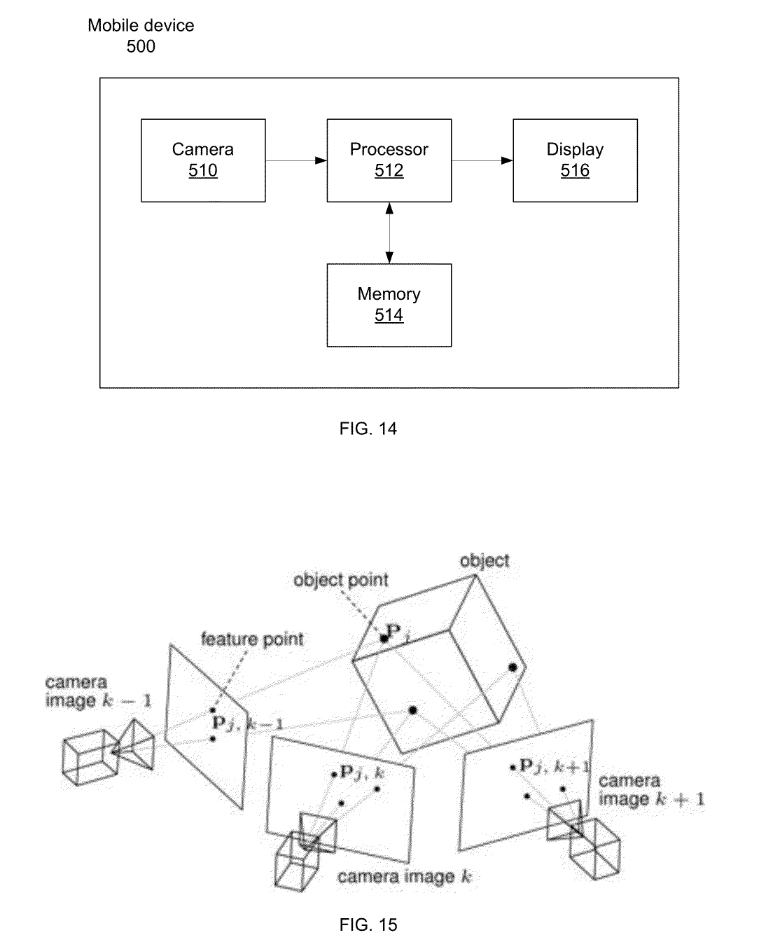

FIG. 14 shows blocks of a mobile device 500, in accordance with some embodiments of the present invention. The mobile device 500 includes a camera 510, a processor 512 having memory 514, and a display 516. The processor 512 is coupled to receive images of a 3-D object from the camera 510. The camera 510 captures at least two still frames, use as the first and second images 110 and 120. Alternatively, the camera 510 captures a sequence of images 100, such as a video stream. The processor then selects two images as the first and second images 110 and 120. The processor determines a set of feature points that have correspondences, meet a homographic model, and are close to a fundamental matrix to form a set of 3-D points and a 3-D surface. The processor 512 is also coupled to the display 516 to show the 3-D surface of the 3-D model.

FIG. 15 illustrates a relationship among selected images, in accordance with some embodiments of the present invention. The camera 510 takes a first image 110 (at camera position k−1), a second image 120 (at camera position k), and a third image (at camera position k+1). Each image includes a picture of a 3-D object having an object point P₃. The processor 512 detects the feature points in each image. The single object point P₃ is represented in the three images as feature points P_{j,k-1}, P_{j,k}, and P_{j,k+1}, respectively.

In a first pass, the processor 512 uses a correlator to relate the three feature points as a common feature point having a correspondence between pairs of feature points of successive images. Therefore, feature points having correspondences progress and other feature points are discarded.

The processor 512 divides up the image into a first set of grids. A RANSAC algorithm or the like is used to form a separate planar homograph model for each grid cell. In a second pass, feature points fitting (as inliers of) a homograph model progress and outlier are discarded.

The processor 512 computes a fundamental matrix from a distributed subset of feature points. In a third pass, the processor 512 matches the feature points to a model defined by the fundamental matrix. That is, the fundamental matrix is applied to feature points (feature points 114 of the first image 110 with a correspondence in the second image 120 and that match the appropriate homographic model) to find inliers.

The processor 512 models a 3-D surface and a 3-D object using these inliers. The processor 512 triangulates the three feature points P_{j,k-1}, P_{j,k}, and P_{j,k+1} to form a 3-D point, which represents the object point feature points Pⱼ,. The processor 512 triangulates the remaining candidate feature points to form a 3-D point cloud. Finally, a 3-D point cloud is used to form 3-D surface(s), which is shown as a 3-D model.

The processor 512 uses first fundamental matrix shows how the camera 510 translated and rotated from the first image 110 (camera image k−1) to the second image 120 (camera image k). A second fundamental matrix shows how the camera 510 translated and rotated from the second image 120 (a next first image 110′ or camera image k) to a next second image 120′ (camera image k+1). Iteratively, the processor 512 forms essential matrices to define movement between iterations. The processor 512 may perform a matrix product of the iterative essential matrices to form a fundamental matrix that defines translation and rotation from a first image through to a last image.

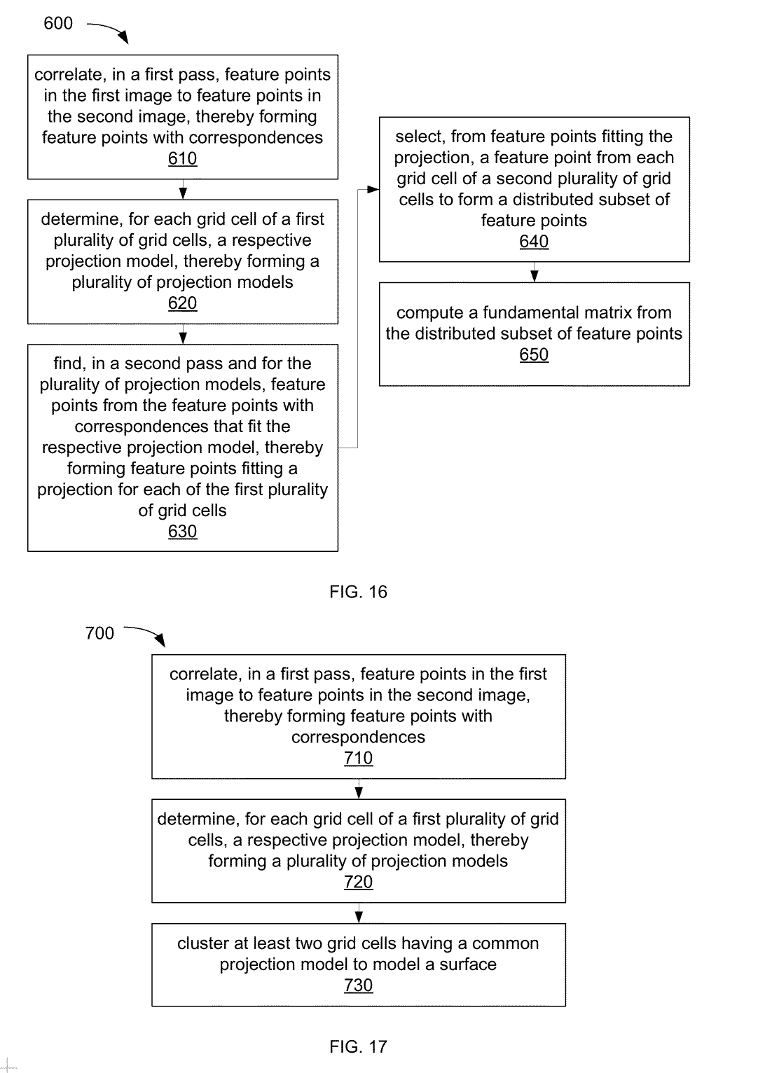

FIGS. 16 and 17 show methods, in accordance with some embodiments of the present invention. In FIG. 16, a method 600 in a mobile device determines a 3-D point cloud from a first image and a second image. At 610, a processor correlates, in a first pass, feature points in the first image to feature points in the second image, thereby forming feature points with correspondences. At 620, the processor determines, for each grid cell of a first plurality of grid cells, a respective projection model, thereby forming a plurality of projection models. At 630, the processor finds, in a second pass and for the plurality of projection models, feature points from the feature points with correspondences that fit the respective projection model, thereby forming feature points fitting a projection for each of the first plurality of grid cells. At 640, the processor selects, from feature points fitting the projection, a feature point from each grid cell of a second plurality of grid cells to form a distributed subset of feature points. At 650, the processor computes a fundamental matrix from the distributed subset of feature points.

In FIG. 17, a method 700 in a mobile device determines a 3-D point cloud from a first image and a second image. At 710, the processor correlates, in a first pass, feature points in the first image to feature points in the second image, thereby forming feature points with correspondences. At 720, the processor determines, for each grid cell of a first plurality of grid cells, a respective projection model, thereby forming a plurality of projection models. At 730, the processor clusters at least two grid cells having a common projection model to model a surface.

Some embodiments comprise a method in a mobile device for determining a three-dimensional (3-D) point cloud from a first image and a second image, the method comprising: correlating, in a first pass, feature points in the first image to feature points in the second image, thereby forming feature points with correspondences; determining, for each grid cell of a first plurality of grid cells, a respective projection model, thereby forming a plurality of projection models; and clustering at least two grid cells having a common projection model to model a surface.

Some embodiments comprise: wherein correlating the feature points in the first image to the corresponding feature points in the second image comprises: determining a binary robust independent elementary features (BRIEF) descriptor of the feature point in the first image; determining a BRIEF descriptor of the feature point in the second image; and comparing the BRIEF descriptor of the feature point in the first image to the BRIEF descriptor of the feature point in the second image.

Some embodiments comprise: wherein determining the respective projection model comprises determining a homography model.

Some embodiments comprise: wherein determining the respective projection model comprises executing, for each grid cell of the first plurality of grid cells, a randomly sampling consensus (RANSAC) algorithm to separate the feature points with correspondences for the grid cell into outliers and inliers of the respective projection model, wherein the inliers form the feature points fitting the respective projection for each of the first plurality of grid cells.

Some embodiments comprise: a mobile device for determining a three-dimensional (3-D) point cloud from a first image and a second image, the mobile device comprising: a camera; a display, wherein the display displays the 3-D point cloud; a processor coupled to the camera and the display; and wherein the processor comprises instructions configured to: correlate, in a first pass, feature points in the first image to feature points in the second image, thereby forming feature points with correspondences; determine, for each grid cell of a first plurality of grid cells, a respective projection model, thereby forming a plurality of projection models; and cluster at least two grid cells having a common projection model to model a surface.

Some embodiments comprise: wherein the respective projection model comprises a homography model.

Some embodiments comprise: A mobile device for determining a three-dimensional (3-D) point cloud from a first image and a second image, the mobile device comprising: means for correlating, in a first pass, feature points in the first image to feature points in the second image, thereby forming feature points with correspondences; means for determining, for each grid cell of a first plurality of grid cells, a respective projection model, thereby forming a plurality of projection models; and means for clustering at least two grid cells having a common projection model to model a surface.

Some embodiments comprise: wherein the respective projection model comprises a homography model.

Some embodiments comprise: a non-transient computer-readable storage medium including program code stored thereon for determining a three-dimensional (3-D) point cloud from a first image and a second image, comprising program code to: correlate, in a first pass, feature points in the first image to feature points in the second image, thereby forming feature points with correspondences; determine, for each grid cell of a first plurality of grid cells, a respective projection model, thereby forming a plurality of projection models; and cluster at least two grid cells having a common projection model to model a surface.

Some embodiments comprise: wherein the respective projection model comprises a homography model.

Some embodiments comprise: a method in a mobile device for determining a three-dimensional (3-D) point cloud from successive images comprising a first image, a second image and a third image, the method comprising: correlating feature points in the first image to feature points in the second image, thereby forming a first set of correspondences; correlating feature points in the second image to feature points in the third image, thereby forming a second set of correspondences; finding a 2-D point in the first image and a 2-D point in the third image that is in both the first set of correspondences and the second set of correspondences; and triangulating a 3-D point from the 2-D point in the first image and the 2-D point in the third image to form the 3-D point in the 3-D point cloud.

Some embodiments comprise: wherein the feature point is represented by a binary descriptor.

Some embodiments comprise: wherein the binary descriptor is a binary robust independent elementary features (BRIEF) descriptor.

Some embodiments comprise: further comprising: correlating feature points in the third image to feature points in a fourth image, thereby forming a third set of correspondences; finding a 2-D point in the first image and a 2-D point in the fourth image that is in the first set of correspondences, the second set of correspondences and the third set of correspondences; and triangulating a 3-D point from the 2-D point in the first image and the 2-D point in the fourth image to form the 3-D point in the 3-D point cloud.

Some embodiments comprise: a mobile device for determining a three-dimensional (3-D) point cloud, the mobile device comprising: a camera configured to capture successive images comprising a first image, a second image and a third image; a processor coupled to the camera; and memory coupled to the processor comprising code to: correlate feature points in the first image to feature points in the second image, thereby forming a first set of correspondences; correlate feature points in the second image to feature points in the third image, thereby forming a second set of correspondences; find a 2-D point in the first image and a 2-D point in the third image that is in both the first set of correspondences and the second set of correspondences; and triangulate a 3-D point from the 2-D point in the first image and the 2-D point in the third image to form the 3-D point in the 3-D point cloud.

Some embodiments comprise: wherein the feature point is represented by a binary descriptor.

Some embodiments comprise: wherein the binary descriptor is a binary robust independent elementary features (BRIEF) descriptor.

Some embodiments comprise: The mobile device of claim [0094], wherein the memory further comprises code to: correlate feature points in the third image to feature points in a fourth image, thereby forming a third set of correspondences; find a 2-D point in the first image and a 2-D point in the fourth image that is in the first set of correspondences, the second set of correspondences and the third set of correspondences; and triangulate a 3-D point from the 2-D point in the first image and the 2-D point in the fourth image to form the 3-D point in the 3-D point cloud.

Some embodiments comprise: a mobile device for determining a three-dimensional (3-D) point cloud from successive images comprising a first image, a second image and a third image, the mobile device comprising: means for correlating feature points in the first image to feature points in the second image, thereby forming a first set of correspondences; means for correlating feature points in the second image to feature points in the third image, thereby forming a second set of correspondences; means for finding a 2-D point in the first image and a 2-D point in the third image that is in both the first set of correspondences and the second set of correspondences; and means for triangulating a 3-D point from the 2-D point in the first image and the 2-D point in the third image to form the 3-D point in the 3-D point cloud.

Some embodiments comprise: wherein the feature point is represented by a binary descriptor.

Some embodiments comprise: wherein the binary descriptor is a binary robust independent elementary features (BRIEF) descriptor.

Some embodiments comprise: further comprising: means for correlating feature points in the third image to feature points in a fourth image, thereby forming a third set of correspondences; means for finding a 2-D point in the first image and a 2-D point in the fourth image that is in the first set of correspondences, the second set of correspondences and the third set of correspondences; and means for triangulating a 3-D point from the 2-D point in the first image and the 2-D point in the fourth image to form the 3-D point in the 3-D point cloud.

Some embodiments comprise: a non-transient computer-readable storage medium including program code stored thereon for determining a three-dimensional (3-D) point cloud from a first image, a second image and a third image, comprising program code to: correlate feature points in the first image to feature points in the second image, thereby forming a first set of correspondences; correlate feature points in the second image to feature points in the third image, thereby forming a second set of correspondences; find a 2-D point in the first image and a 2-D point in the third image that is in both the first set of correspondences and the second set of correspondences; and triangulate a 3-D point from the 2-D point in the first image and the 2-D point in the third image to form the 3-D point in the 3-D point cloud.

Some embodiments comprise: wherein the program code further comprises code to: correlate feature points in the third image to feature points in a fourth image, thereby forming a third set of correspondences; find a 2-D point in the first image and a 2-D point in the fourth image that is in the first set of correspondences, the second set of correspondences and the third set of correspondences; and triangulate a 3-D point from the 2-D point in the first image and the 2-D point in the fourth image to form the 3-D point in the 3-D point cloud.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

What is claimed is:

1. A method in a mobile device for determining feature points from a first image and a second image, the method comprising:
correlating, in a first pass, feature points in the first image to feature points in the second image, thereby forming feature points with correspondences;
determining, for each grid cell of a first plurality of grid cells, a respective projection model, thereby forming a plurality of projection models;
finding, in a second pass and for the plurality of projection models, feature points from the feature points with correspondences that fit the respective projection model, thereby forming feature points fitting a projection for each of the first plurality of grid cells; and
selecting, from feature points fitting the projection, a feature point from each grid cell of a second plurality of grid cells to form a distributed subset of feature points.

2. The method of claim 1, further comprising computing a fundamental matrix from the distributed subset of feature points.

3. The method of claim 1, further comprising computing an essential matrix from the fundamental matrix multiplied by an intrinsic matrix.

4. The method of claim 1, wherein the respective projection model comprises a planar projection model.

5. The method of claim 1, wherein correlating the feature point in the first image to the corresponding feature point in the second image comprises:
determining a binary robust independent elementary features (BRIEF) descriptor of the feature point in the first image;
determining a BRIEF descriptor of the feature point in the second image; and
comparing the BRIEF descriptor of the feature point in the first image to the BRIEF descriptor of the feature point in the second image.

6. The method of claim 1, wherein determining the respective projection model comprises determining a homography model.

7. The method of claim 1, wherein determining the respective projection model comprises executing, for each grid cell of the first plurality of grid cells, a randomly sampling consensus (RANSAC) algorithm to separate the feature points with correspondences for the grid cell into outliers and inliers of the respective projection model, wherein the inliers form the feature points fitting the respective projection for each of the first plurality of grid cells.

8. The method of claim 1, wherein finding the feature points that fit the respective projection model comprises allowing a correspondence to be within N pixels of the respective projection model.

9. The method of claim 1, wherein selecting the distributed subset of feature points comprises finding a minimum Hamming distance between a correspondence and the projection model.

10. The method of claim 1, wherein selecting the feature point from each grid cell of the second plurality of grid cells comprises selecting the feature point meeting the respective projection model.

11. The method of claim 1, wherein the first plurality of grid cells has lower resolution than the second plurality of grid cells.

12. The method of claim 1, further comprising:
matching, in a third pass, feature points fitting the projection that fit the fundamental matrix, thereby forming feature points fitting the fundamental matrix; and
triangulating the feature points fitting the fundamental matrix, thereby forming the three-dimensional (3-D) point cloud.

13. The method of claim 1, further comprising:
providing a next first image and a next second image; and
repeating, with the next first image and the next second image, correlating, determining, finding, selecting and computing to form a second fundamental matrix.

14. The method of claim 13, further comprising forming a product of the fundamental matrix from the first image and the second image with the second fundamental matrix from the next first image and the next second image.

15. The method of claim 1, further comprising decomposing the fundamental matrix into a rotation matrix and a translation matrix.

16. The method of claim 1, wherein matching the feature points with correspondences to points found using the fundamental matrix comprises allowing a correspondence to be within M pixels from the fundamental matrix.

17. The method of claim 1, further comprising forming a three-dimensional (3-D) surface of the 3-D model from the 3-D point cloud.

18. The method of claim 16, further comprising displaying the 3-D surface.

19. The method of claim 1, further comprising forming a three-dimensional (3-D) model from the 3-D point cloud.

20. A mobile device for determining feature points from a first image and a second image, the mobile device comprising:
a camera;
a display, wherein the display displays the 3-D point cloud;
a processor coupled to the camera and the display; and
wherein the processor comprises instructions configured to:
correlate, in a first pass, feature points in the first image to feature points in the second image, thereby forming feature points with correspondences;
determine, for each grid cell of a first plurality of grid cells, a respective projection model, thereby forming a plurality of projection models;
find, in a second pass and for the plurality of projection models, feature points from the feature points with correspondences that fit the respective projection model, thereby forming feature points fitting a projection for each of the first plurality of grid cells; and
select, from feature points fitting the projection, a feature point from each grid cell of a second plurality of grid cells to form a distributed subset of feature points.

21. The mobile device of claim 20, wherein the instructions further comprise instructions configured to compute a fundamental matrix from the distributed subset of feature points.

22. The mobile device of claim 20, wherein the instructions further comprise instructions configured to compute an essential matrix from the fundamental matrix multiplied by an intrinsic matrix.

23. The mobile device of claim 20, wherein the respective projection model comprises a planar projection model.

24. The mobile device of claim 20, wherein the processor further comprising instructions configured to:
match, in a third pass, feature points fitting the projection that fit the fundamental matrix, thereby forming feature points fitting the fundamental matrix; and
triangulate the feature points fitting the fundamental matrix, thereby forming the three-dimensional (3-D) point cloud.

25. The mobile device of claim 20, wherein the processor further comprising instructions configured to:
provide a next first image and a next second image; and
repeat, with the next first image and the next second image, the instructions configured to correlate, determine, find, select and compute to form a second fundamental matrix.

26. The mobile device of claim 25, wherein the processor further comprising instructions configured to form a product of the fundamental matrix from the first image and the second image with the second fundamental matrix from the next first image and the next second image.

27. A mobile device for determining feature points from a first image and a second image, the mobile device comprising:
means for correlating, in a first pass, feature points in the first image to feature points in the second image, thereby forming feature points with correspondences;
means for determining, for each grid cell of a first plurality of grid cells, a respective projection model, thereby forming a plurality of projection models;
means for finding, in a second pass and for the plurality of projection models, feature points from the feature points with correspondences that fit the respective projection model, thereby forming feature points fitting a projection for each of the first plurality of grid cells; and
means for selecting, from feature points fitting the projection, a feature point from each grid cell of a second plurality of grid cells to form a distributed subset of feature points

28. The mobile device of claim 27, further comprising means for computing an fundamental matrix from the distributed subset of feature points.

29. The mobile device of claim 27, further comprising means for computing an essential matrix from the fundamental matrix multiplied by an intrinsic matrix.

30. The mobile device of claim 27, wherein the respective projection model comprises a planar projection model.

31. The mobile device of claim 27, further comprising:
means for matching, in a third pass, feature points fitting the projection that fit the fundamental matrix, thereby forming feature points fitting the fundamental matrix; and
means for triangulating the feature points fitting the fundamental matrix, thereby forming a three-dimensional (3-D) point cloud.

32. The mobile device of claim 27, further comprising:
means for providing a next first image and a next second image; and
means for repeating, with the next first image and the next second image, the means for correlating, means for determining, means for finding, means for selecting and means for computing to form a second fundamental matrix.

33. The mobile device of claim 32, further comprising means for forming a product of the fundamental matrix from the first image and the second image with the second fundamental matrix from the next first image and the next second image.

34. A non-transient computer-readable storage medium including program code stored thereon for determining feature points from a first image and a second image, comprising program code to:
correlate, in a first pass, feature points in the first image to feature points in the second image, thereby forming feature points with correspondences;
determine, for each grid cell of a first plurality of grid cells, a respective projection model, thereby forming a plurality of projection models;
find, in a second pass and for the plurality of projection models, feature points from the feature points with correspondences that fit the respective projection model, thereby forming feature points fitting a projection for each of the first plurality of grid cells; and
select, from feature points fitting the projection, a feature point from each grid cell of a second plurality of grid cells to form a distributed subset of feature points.

35. The non-transient computer-readable storage medium of claim 34, wherein the program code further comprises code to compute a fundamental matrix from the distributed subset of feature points.

36. The non-transient computer-readable storage medium of claim 34, wherein the program code further comprises code to compute an essential matrix from the fundamental matrix multiplied by an intrinsic matrix.

37. The non-transient computer-readable storage medium of claim 34, wherein the respective projection model comprises a planar projection model.

38. The non-transient computer-readable storage medium of claim 34, further comprising code to:
match, in a third pass, feature points fitting the projection that fit the fundamental matrix, thereby forming feature points fitting the fundamental matrix; and
triangulate the feature points fitting the fundamental matrix, thereby forming the three-dimensional (3-D) point cloud.

39. The non-transient computer-readable storage medium of claim 34, further comprising program code to:
provide a next first image and a next second image; and
repeat, with the next first image and the next second image, the code to correlate, determine, find, select and compute to form a second fundamental matrix.

40. The non-transient computer-readable storage medium of claim 39, further comprises program code to forming a product of the fundamental matrix from the first image and the second image with the second fundamental matrix from the next first image and the next second image.
